(19) United States
(12) Patent Application Publication
(10) Pub. No.: US 2008/0087188 A1
(43) Pub. Date: Apr. 17, 2008

(54) INK COMPOSITIONS AND METHODS FOR MAKING THE SAME

(76) Inventor: Alexey S. Kabalnov, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/690,205

(22) Filed: Mar. 23, 2007

Related U.S. Application Data
(63) Continuation-in-part of application No. 11/581,182, filed on Oct. 13, 2006.

(51) Int. Cl. C09D 11/00

(52) U.S. Cl. 106/31.6

(57) ABSTRACT

An ink composition includes a solvent system present in an amount ranging from about 10 wt % to about 25 wt %. The solvent system includes a betaine solvent and 2-pyrrolidone, glycerol, or combinations thereof. The ink composition further includes at least one surfactant in an amount up to about 10 wt %; at least one polymeric binder in an amount ranging from about 2 wt % to about 6 wt %; water; and a pigment present in an amount ranging from about 0.1 wt % to about 5 wt %.

### CROSS REFERENCE TO RELATED APPLICATIONS

This application is a continuation-in-part of co-pending U.S. patent application Ser. No. 11/581,182, filed Oct. 13, 2006, entitled “Ink Compositions and Methods for Making the Same,” which application is incorporated by reference herein in its entirety.

### BACKGROUND

The present disclosure generally relates to ink compositions and methods for making the same.

Inkjet printing or recording systems are commonly used as an effective way of producing images on a print medium, such as paper. Generally, ink droplets are ejected from a nozzle at high speed by the inkjet recording system and onto the paper to produce an image thereon. The ink droplets are generally composed of a recording agent, such as a pigment, and a liquid vehicle, where the liquid vehicle generally includes water, one or more water-soluble organic solvents and other additives if desired.

It is generally advantageous to have an ink that will produce an image having desirable properties, including glossiness, low bronzing effect, rub resistance, and/or smear resistance. These image properties may generally be obtained using relatively high amounts of polymeric binders in the ink composition. The presence of such high amounts of polymeric binders, however, may in some instances generate problems with regard to poor decap time and/or nozzle clogging, both of which may deleteriously affect drop spreading of the ink on the print medium. A substantial concentration of organic solvent(s) may be used to dissolve the binders and to improve the overall print quality. However, some organic solvents or solvent systems tend to produce an undesirably pungent smell and may have undesirably high toxicity levels.

### DETAILED DESCRIPTION

Embodiment(s) of the ink composition disclosed herein are pigmented inks, suitable for drop-on-demand inkjet printing, that may advantageously exhibit desirable decap time(s), higher resistance to rubbing and/or smearing, reduced nozzle clogging, reduced streaking, good recoverability after storage, and low odor and toxicity levels, while maintaining an effective amount of polymeric binders therein. The inks disclosed herein may also exhibit desirable levels of glossiness and low bronzing.

The term “decap,” as referred to herein, means the ability of the ink to readily eject from an ink printhead upon prolonged exposure to air. The ink decap time is measured as the amount of time that the ink printhead may be left uncapped before the printer nozzle no longer fires properly, potentially because of clogging or plugging. Generally, the nozzle may become clogged/plugged by a viscous plug that forms in the nozzle as a result of water loss, crusting of the ink, and/or agglomeration of the pigment in and/or around any of the nozzles. If a nozzle has been plugged, ink droplets ejected through the nozzle's orifice may be misdirected, which may adversely affect print quality. The orifice may also become completely blocked and, as a result, the ink droplets may not pass through the affected nozzle.

The term “bronzing,” as used herein, refers to the phenomenon that a printed image has a metallic luster appearance rather than its intended color when viewed at an angle. Bronzing often manifests as a magenta sheen over cyan area fills, and a yellowish to reddish to bluish sheen over gray area fills. Generally, bronzing may be most severe at high gloss areas, and decreases at lower gloss areas.

The phrase “effective amount,” as used herein, refers to the minimal amount of a substance and/or agent, which is sufficient to achieve a desired and/or required effect. For example, an effective amount of an “ink vehicle” is the minimum amount required in order to create an ink composition, while maintaining properties suitable for effective inkjet printing.

Without being bound to any theory, it is believed that the combination of a betaine solvent and another organic solvent selected from glycerol and/or 2-pyrrolidone in the ink composition permits the ink composition to accommodate an effective amount of polymeric binders. It is further believed that the effective amount of polymeric binders in the ink composition improves image properties including desirable levels of glossiness, low bronzing and relatively high resistance to rubbing and/or smearing. It is also believed that the betaine and glycerol and/or 2-pyrrolidone solvent system allows the ink composition to exhibit more desirable decap times, less nozzle clogging, less streaking, better recoverability after storage, and lower odor and toxicity levels.

Embodiment(s) of the ink composition include an ink vehicle and a pigment. As used herein, the term “ink vehicle” refers to the combination of water and solvents (and additives, if desired) to form a vehicle in which a colorant is placed to form an ink composition. It is to be understood that the ink vehicle for embodiments of the ink composition as disclosed herein is suitable for pigmented inkjet ink compositions.

In an embodiment, the ink vehicle of the ink composition includes a betaine and glycerol solvent system, a betaine and 2-pyrrolidone solvent system, or a betaine, 2-pyrrolidone and glycerol solvent system, at least one surfactant, at least one polymeric binder, and water. Additives may also be incorporated in the ink vehicle. As used herein, the phrase “solvent system” refers to the combination of two or more organic solvents. An organic solvent is an organic or carbon-based compound that operates to dissolve a solute, thereby resulting in a solution. The solvent system is generally present in the ink vehicle in an amount ranging from about 10 wt % to about 25 wt %. In a non-limiting example, the solvent system is present in the ink vehicle in an amount ranging from about 15 wt % to about 20 wt %.

The betaine constituent of the solvent system has a chemical structure represented by the formula (R₃)N⁺—CH₂—COO⁻, where R is CH₃. Without being bound to any theory, it is believed that because of its chemical structure, the betaine constituent of the solvent system acts as a solvent in the ink composition. This may be due, at least in part, to the fact that embodiment(s) of the betaine chemical structures disclosed herein generally do not have both a hydrophobic end and a hydrophilic end. Generally, betaine structures including both hydrophobic and hydrophilic ends act as surfactants, whereas the absence of one of such groups (i.e., both ends are hydrophilic or both ends are hydrophobic) is indicative of a solvent. Unlike betaine solvents, betaine surfactants generally have a low molecular solubility in water (i.e., critical micelle concentration). At any point above the critical micelle concentration, the betaine surfactant molecules tend to aggregate into micelles. Furthermore, betaine surfactants tend to adsorb at interfaces between the ink and the print medium, which may affect drop spreading on the print medium. Thus, image properties such as bleed control, dot gain and drying time may be deleteriously affected. The betaine solvent may be present in an amount ranging from about 5 wt % to about 15 wt %. As a non-limiting example, the betaine solvent constitutes about 10 wt % of the total ink composition.

In an embodiment, the glycerol constituent of the solvent system is represented as a water-soluble organic solvent. The glycerol solvent may be present in an amount ranging from about 5 wt % to about 15 wt %. In a non-limiting example, the glycerol solvent constitutes about 10 wt % of the total ink composition.

In another embodiment, the solvent system of the ink vehicle includes a betaine solvent and a 2-pyrrolidone solvent. Without being bound to any theory, it is believed that 2-pyrrolidone is a suitable substitute for glycerol to achieve the desired advantages of embodiment(s) of the ink composition as disclosed herein. The 2-pyrrolidone component of the solvent system is a water-soluble organic solvent that may be present in an amount ranging from about 5 wt % to about 15 wt %. In a non-limiting example, the 2-pyrrolidone solvent constitutes about 10 wt % of the total ink composition.

In yet another embodiment, the solvent system of the ink vehicle may include a betaine solvent, glycerol and 2-pyrrolidone. As a non-limiting example, the glycerol constituent may be present in an amount ranging from about 3 wt % to about 15 wt %, and the 2-pyrrolidone constituent may be present in an amount ranging from about 3 wt % to about 15 wt % of the ink composition.

Still another embodiment of the ink composition may include diethylene glycol in addition to any of the betaine solvent systems disclosed herein. Generally, the diethylene glycol solvent is present in an amount ranging from about 0 wt % to about 10 wt %. In a non-limiting example, the diethylene glycol is present in an amount ranging from about 0 wt % to about 5 wt %. In another non-limiting example, from about 0.3 wt % to about 0.9 wt % of the diethylene glycol solvent is present in the composition.

Surfactants are included in the ink composition to assist in controlling the physical properties of the ink, such as jetting stability, waterproofness and bleeding. One or more surfactants may be used in the formulation of the ink. Some surfactant(s) (e.g., 1,2-diglycols or other non-ionic surfactants) may be present in larger amounts, for example, up to about 10 wt %. In an embodiment, the surfactant amount ranges from about 1 wt % to about 10 wt %. Other surfactants may be included in the ink composition in smaller amounts, for example, from about 0.1 wt % to about 5 wt %. In a non-limiting example embodiment, the ink includes from about 0.2 wt % to about 1 wt % of surfactant(s).

The surfactant(s) used for embodiment(s) of the formulation of the ink is nonionic or anionic, and is generally a water-soluble organic ether or alcohol. Several commercially available nonionic surfactants may suitably be used in the formulation of the ink, examples of which include ethoxylated alcohols such as those from the Tergitol® series (e.g., Tergitol® 15S5, Tergitol® 15S7), manufactured by Union Carbide, located in Houston, Tex.; surfactants from the Surfynol® series (e.g. Surfynol® 440 and Surfynol® 465), manufactured by Air Products and Chemicals, Inc., located in Allentown, Pa.; fluorinated surfactants, such as those from the Zonyl® family (e.g., Zonyl® FSO and Zonyl® FSN surfactants), manufactured by E.I. duPont de Nemours Company, located in Wilmington, Del.; fluorinated PolyFox® nonionic surfactants (e.g., PG-154 nonionic surfactants), manufactured by Omnova, located in Fairlawn, Ohio; 2-diglycol surfactants, such as 1,2 hexanediol or 1,2-octanediol; or combinations thereof.

Suitable anionic surfactants that may be used in the ink composition include surfactants of the Dowfax® family (e.g., Dowfax® 8390), manufactured by Dow Chemical Company, located in Midland, Mich., or anionic Zonyl® surfactants (e.g., Zonyl® FSA), manufactured by E.I. duPont de Nemours Company; or combinations thereof.

It is to be understood that any of the surfactants may be included in the ink vehicle as supplied by the manufacturer.

Embodiments of the ink composition may also include triethanolamine (TEA) in the ink vehicle. In an embodiment, triethanolamine is present in an amount ranging from about 0.5 wt % to about 2 wt %. As a non-limiting example, about 0.8 wt % of triethanolamine is present in the ink composition.

Polymeric binders are particularly beneficial for stabilizing the ink composition for improved water and rub resistance, relatively good durability, relatively good gloss and low bronzing of the ink on the print media. The polymeric binder is generally water-soluble, and may be selected from those of the salts of styrene-(meth)acrylic acid copolymers, polyurethanes, other similar polymeric binders, or combinations thereof.

As a non-limiting example, one class of polymeric binders suitable for use in the ink include salts of styrene-(meth)acrylic acid copolymers. A salt of a styrene-(meth)acrylic acid copolymer includes at least a styrene skeleton and a skeleton of the salt of the styrene-(meth)acrylic acid copolymer in its structure. It may also contain a skeleton derived from a monomer having another unsaturated group, such as a (meth)acrylate skeleton, in its structure. Suitable non-limiting examples of styrene-(meth)acrylic acid copolymers are commercially available and may be selected from the Joncryl® series (e.g., Joncryl® 586, 683, and 683K), manufactured by BASF, Corp. located in Florham Park, N.J.; SMA-1000Na, SMA-1000HNa, and SMA-1440K manufactured by Sartomer, located in Exton, Pa.; Disperbyk 190, manufactured by BYK Chemicals, located in Wallingford, Conn.; polystyrene-acrylic polymers manufactured by Gifu Shellac, located in Japan; or combinations thereof. Polyurethanes may also be used as a suitable polymeric binder. Non-limiting examples of polyurethanes include those that are commercially available from Dainippon Ink & Chem, Inc. (DIC), located in Osaka, Japan.

Blends of the polymeric binders may also be used. Such polymeric binder combinations may be beneficial for improving rub resistance and gloss control (e.g., a blend of SMA 1000 Na and Joncryl® 683).

The polymeric binder concentration in an embodiment of the ink ranges from about 2 wt % to about 6 wt %. In an embodiment, the polymeric binder is present in an amount ranging from about 2 wt % to about 5 wt %. Percentages higher than 6 wt %, however, will generally not be advantageous for the ink composition as nozzle clogging may arise due, at least in part, to over-thickening of the ink.

Additives may also be incorporated into embodiment(s) of the ink composition. As used herein, the term “additives” refers to constituents of the ink that operate to enhance performance, environmental effects, aesthetic effects, or other similar properties of the ink. Examples of additives include buffers, biocides, sequestering agents, chelating agents, or the like, or combinations thereof.

As a non-limiting example, bactericides, such as Proxel® GXL, may be added to the ink to protect the ink from bacterial growth. Another non-limiting example of an additive is a chelating agent, such as EDTA disodium salt, for improving kogation of the ink and/or the reliability of the ink by increasing the decap time. The additives, taken together, may be present in the ink in an amount of up to about 0.3 wt %. In an embodiment, the additives constitute from about 0.01 wt % to about 0.2 wt % of the total ink concentration. In another embodiment, no additives are present in the ink.

The ink composition also includes water. Generally, the amount of water is present in an amount ranging from about 60 wt % to about 80 wt %. The amount of water may be increased or decreased as desired.

The ink vehicle is combined with a pigment to form the ink composition. As used herein, the term “pigment” refers to a colorant particle that is substantially insoluble in the liquid vehicle in which it is used. Suitable pigments include self-dispersed pigments and non-self-dispersed pigments. Self-dispersed pigments include those that have been chemically modified at the surface with a charge or a polymeric grouping. This chemical modification aids the pigment in becoming and/or substantially remaining dispersed in a liquid. A non-self-dispersed pigment utilizes a separate and unattached dispersing agent (e.g., polymers, oligomers, surfactants, etc.) in the liquid vehicle or physically coated on the surface of the pigment. The amount of pigment present in the ink composition ranges from about 0.1 wt % to about 5 wt %. In an embodiment, the amount of pigment present ranges from about 0.2 wt % to about 5 wt %. In still another embodiment, the amount of pigment ranges from about 0.3 wt % to about 0.9 wt %.

Some non-limiting examples of suitable pigments for the ink include pigment cyan (PB) 15:3, pigment magenta (PR) 122, pigment yellow (PY) 155, PY 74, pigment red (PR) 168, pigment green (PG) 36, pigment violet (PV) 23, and carbon black (black) microencapsulated pigments. One method for preparing suitable pigment dispersions is described in Japanese Patent No. JP2003226831 A to Kaji et al., which is incorporated herein by reference in its entirety.

Examples of other suitable black pigments include Raven 7000, Raven 5750, Raven 5250, Raven 5000, and Raven 3500 (all of which are commercially available from Columbian Chemicals, Co. located in Marietta, Ga.). Other examples of suitable black pigments include Color Black FW 200, Color Black FW 2, Color Black FW 2V, Color Black FW 1, Color Black FW 18, Color Black S 160, Color Black S 170, Special Black 6, Special Black 5, Special Black 4A, Special Black 4 (all of which are commercially available from Degussa Corp. located in Parsippany, N.J.), and self-dispersed black pigments such as Cabo-Jet® 200 and Cabo-Jet® 300, manufactured by Cabot Corporation, located in Bellrica, Mass.

Examples of suitable classes of colored pigments include, but are not limited to anthraquinones, phthalocyanine blues, phthalocyanine greens, diazos, monoazos, pyranthrones, perylenes, heterocyclic yellows, quinacridones, and (thio)indigoids. Non-limiting examples of phthalocyanine blues include copper phthalocyanine blue and derivatives thereof (e.g., PB15). Examples of quinacridones include, but are not limited to pigment orange (PO) 48, P049, PR122, PR192, PR202, PR206, PR207, PR209, pigment violet (PV) 19, PV42, or combinations thereof. Non-limiting examples of anthraquinones include PR43, PR194 (perinone red), PR216 (brominated pyrathrone red), PR226 (pyranthrone red), or combinations thereof. Perylene pigment examples include, but are not limited to PR123 (vermillion), PR149 (scarlet), PR179 (maroon), PR190 (red), PR189 (yellow shade red), PR224, or combinations thereof. Non-limiting examples of thioindigoids include PR86, PR87, PR88, PR181, PR198, PV36, PV38, or combinations thereof. Examples of suitable heterocyclic yellow pigments include, but are not limited to PY117, PY138, or combinations thereof. Examples of other suitable colored pigments are described in Colour Index, 3rd edition (The Society of Dyers and Colourists, 1982).

As a non-limiting example, the pigment selected for the ink may be a self-dispersible anionic pigment. Such pigments are made self-dispersable by the incorporation of carboxylate and/or sulfonate functionalities. The anionic pigments may be associated with Na⁺, Li⁺, and NH₄⁺cations, although other suitable counter-ions may be used herein.

In an embodiment, the ink composition includes a combination of a variety of different colored pigments. A non-limiting example of such a combination includes cyan, black and violet pigments present in an amount sufficient to produce a desirable shade (i.e., light, medium, dark) of gray ink. One embodiment of this pigment combination includes the cyan pigment present in an amount ranging from about 0.05 wt % to about 0.2 wt %, the black pigment present in an amount ranging from about 0.1 wt % to about 0.6 wt %, and the violet pigment present in an amount ranging from about 0.03 wt % to about 0.2 wt %.

Forming embodiment(s) of the ink composition includes providing or making the ink vehicle and adding an effective amount of pigment thereto. Without being bound to any theory, it is believed that the embodiment(s) of the ink disclosed above are pigmented inks. As such, embodiments of the ink composition generally do not include dyes.

In an embodiment of a method of using the embodiment(s) of the ink composition, the ink composition is established on at least a portion of the substrate to form an image. The amount of ink composition used depends, at least in part, on the desirable image to be formed. A non-limiting example of a suitable inkjet printing technique includes drop-on-demand inkjet printing, which encompasses thermal and piezoelectric inkjet printing. Suitable printers include portable drop-on-demand inkjet printers (e.g., handheld printers, arm mountable printers, wrist mountable printers, etc.), desktop drop-on-demand inkjet printers, or combinations thereof.

To further illustrate the embodiment(s) of the present disclosure, examples are given herein. It is to be understood that these examples are provided for illustrative purposes and are not to be construed as limiting the scope of the disclosed embodiment(s).

### EXAMPLE

Two ink sets were prepared. One (referred to herein as “Ink Set A”) includes light and medium gray inks formed according to the embodiments disclosed herein. The other is a comparative example (referred to herein as “Ink Set B”) including light and medium gray inks that do not include betaine in the solvent system. Each of the ink sets also included a photo black ink. The formulations for each of ink sets A and B are shown in Tables 1 and 2, respectively.

TABLE 1
Formulation of Inks in Ink Set A

| | Light gray | Medium gray | Photo black |
|---|---|---|---|
| Ink component | (wt %) | (wt %) | (wt %) |
| Pigment Blue 15:3 | 0.06 | 0.19 | 0.49 |
| Carbon black | 0.21 | 0.66 | 2.09 |
| Pigment Violet 23 | 0.04 | 0.13 | 0.41 |
| Binder 1 | 2.00 | 2.00 | — |
| Binder 2 | 0.18 | 0.18 | — |
| Binder 3 - acrylic polymer | — | — | 0.80 |
| Binder 4 - acrylic polymer | 2.00 | 1.00 | |
| Binder 5 - Encapsulating | 0.09 | 0.29 | 0.90 |
| acrylic resin | | | |
| Glycerol polyoxyethyl | — | — | 3.00 |
| ether (LEG-1) | | | |
| Betaine | 10.00 | 10.00 | — |
| Biocide | — | 0.01 | 0.15 |
| Diethylene glycol | 0.31 | 0.98 | 3.00 |
| Glycerol | — | — | 5.00 |
| 2-Pyrrolidone | 12.00 | 12.00 | 6.00 |
| 1,2 hexanediol | 4.00 | 4.00 | 4.00 |
| Triethanolamine | 0.80 | 0.80 | 0.40 |
| Zonyl ® FSO | 0.20 | 0.20 | 0.17 |
| Surfynol ® 440 | 0.20 | 0.20 | — |
| Tergitol ® 15S7 | — | — | 0.25 |
| Tergitol ® 15S9 | — | — | 0.25 |

TABLE 2
Formulation of Inks in Comparative Ink Set B

| | Light gray | Medium gray | Photo black |
|---|---|---|---|
| Ink component | (wt %) | (wt %) | (wt %) |
| Pigment Blue 15:3 | 0.06 | 0.19 | 0.49 |
| Carbon black | 0.21 | 0.66 | 2.09 |
| Pigment Violet 23 | 0.04 | 0.13 | 0.41 |
| Binder 1 | 2.00 | 2.00 | — |
| Binder 2 | 0.18 | 0.18 | — |
| Binder 3 - acrylic polymer | — | — | 0.80 |
| Binder 4 - acrylic polymer | 2.00 | 1.00 | — |
| Binder 5 - Encapsulating | 0.09 | 0.29 | 0.90 |
| acrylic resin | | | |
| Glycerol polyoxyethyl ether | 3.00 | 3.00 | 3.00 |
| (LEG-1) | | | |
| Betaine | — | — | — |
| Biocide | 0.10 | 0.10 | 0.15 |
| Diethylene glycol | 0.31 | 0.98 | 3.00 |
| Glycerol | 5.00 | 5.00 | 5.00 |
| 2-Pyrrolidone | 6.00 | 6.00 | 6.00 |
| 1,2 hexanediol | 4.00 | 4.00 | 4.00 |
| Triethanolamine | 0.40 | 0.40 | 0.40 |
| Zonyl ® FSO | 0.17 | 0.17 | 0.17 |
| Surfynol ® 440 | 0.20 | 0.20 | |
| Tergitol ® 15S7 | — | — | 0.25 |
| Tergitol ® 15S9 | — | — | 0.25 |

The light gray, medium gray and photoblack inks of Ink Set A were printed together on HP Premium Instant Dry Photo Gloss paper using an HP Designjet® Z3100 Photo printer. Similarly, the light gray, medium gray and photoblack inks of Ink Set B were printed together on HP Premium Instant Dry Photo Gloss paper using an HP Designjet® Z3100 Photo printer. In each instance, light gray ink was printed, after which the medium gray and photo black inks were gradually introduced, to create relatively smooth transitions in the tonal curve, substantially without grain. The performance in terms of gloss uniformity and decap are compared in Table 3, below. A sequence of 35 gradations of gray was printed, and the gloss was measured at 20 degrees by using a BYK gloss meter.

TABLE 3
Gloss and Decap Data for Ink Sets A and B

| | Gloss uniformity | Short term decap, |
|---|---|---|
| System | (average/standard deviation) | seconds (delimiting) |
| Ink Set A | 55 ± 10 | 4 s |
| Ink Set B | 49 ± 12 | <2 s |

As depicted in Table 3, the gloss uniformity and decap of Ink set A (having light and medium gray inks formed with embodiments of the solvent system disclosed herein) is better than that of the comparative Ink Set B (formulated without betaine).

While several embodiments have been described in detail, it will be apparent to those skilled in the art that the disclosed embodiments may be modified. Therefore, the foregoing description is to be considered exemplary rather than limiting.

What is claimed is:

1. An ink composition, comprising:
a solvent system present in an amount ranging from about 10 wt % to about 25 wt %, wherein the solvent system includes a betaine solvent and 2-pyrrolidone, glycerol, or combinations thereof;
at least one surfactant present in an amount up to about 10 wt %;
at least one polymeric binder present in an amount ranging from about 2 wt % to about 6 wt %;
water; and
a pigment present in an amount ranging from about 0.1 wt % to about 5 wt %.

2. The ink composition as defined in claim 1 wherein the betaine solvent is represented by the formula (R₃)N⁺—CH₂—COO⁻, wherein R is CH₃.

3. The ink composition as defined in claim 1 wherein the pigment includes a combination of cyan pigment, black pigment, and violet pigment.

4. The ink composition as defined in claim 3 wherein the cyan pigment is present in an amount ranging from about 0.05 wt % to about 0.2 wt %, the black pigment is present in an amount ranging from about 0.1 wt % to about 0.6 wt %, and the violet pigment is present in an amount ranging from about 0.03 wt % to about 0.2 wt %.

5. The ink composition as defined in claim 1 wherein the betaine solvent is present in an amount ranging from about 5 wt % to about 15 wt %.

6. The ink composition as defined in claim 1 wherein the 2-pyrrolidone, glycerol, or the combination thereof is present in an amount ranging from about 5 wt % to about 15 wt %.

7. The ink composition as defined in claim 1, further comprising an additive present in an amount up to about 0.3 wt %.

8. The ink composition as defined in claim 1 wherein the pigment is present in an amount ranging from about 0.1 wt % to about 0.9 wt %.

9. The ink composition as defined in claim 1, further comprising diethylene glycol present in an amount ranging from about 0.3 wt % to about 0.9 wt %.

10. A method of making an ink composition, comprising:
providing an ink vehicle including:
a solvent system present in an amount ranging from about 10 wt % to about 25 wt %, wherein the solvent system includes a betaine solvent and glycerol, 2-pyrrolidone, or combinations thereof;
at least one surfactant present in an amount ranging from about 0 wt % to about 10 wt %;
at least one polymeric binder present in an amount ranging from about 2 wt % to about 6 wt %; and
water; and
adding a pigment in an amount ranging from about 0.1 wt % to about 5 wt % to the ink vehicle.

11. The method as defined in claim 10 wherein the betaine solvent is represented by the formula (R₃)N⁺—CH₂—COO⁻, wherein R is CH₃.

12. The method as defined in claim 10 wherein the surfactant is present in an amount ranging from about 0.2 wt % and about 5 wt %.

13. The method as defined in claim 10 wherein the at least one polymeric binder is present in an amount ranging from about 2 wt % to about 4 wt %.

14. The method as defined in claim 10 wherein the pigment is added in an amount ranging from about 0.1 wt % to about 0.9 wt %.

15. The method as defined in claim 10, further comprising adding, to the ink vehicle, additives in an amount up to about 0.3 wt %.

16. The method as defined in claim 10, further comprising adding, to the ink vehicle, diethylene glycol in an amount ranging from about 0.3 wt % to about 0.9 wt %.

17. The method as defined in claim 10 wherein adding the pigment includes:
adding a cyan pigment in an amount ranging from about 0.05 wt % to about 0.2 wt %;
adding a black pigment in an amount ranging from about 0.1 wt % to about 0.6 wt %; and
adding a violet pigment in an amount ranging from about 0.03 wt % to about 0.2 wt %.

18. A method of forming an image on a substrate, comprising:
providing an ink composition including:
a solvent system present in an amount ranging from about 10 wt % to about 25 wt %, wherein the solvent system includes a betaine solvent represented by the formula (R₃)N⁺—CH₂—COO⁻ and glycerol, 2-pyrrolidone, or combinations thereof, wherein R is CH₃;
at least one surfactant present in an amount ranging from about 0 wt % to about 10 wt %;
at least one polymeric binder present in an amount ranging from about 2 wt % to about 6 wt %;
water; and
a pigment present in an amount ranging from about 0.1 wt % to about 0.9 wt %; and
establishing the ink composition on at least a portion of the substrate.

19. The method as defined in claim 18 wherein establishing the ink on at least a portion of the substrate is accomplished by drop-on-demand inkjet printing, wherein the drop-on-demand inkjet printing is accomplished using a portable thermal inkjet printer, a desktop thermal inkjet printer, a portable piezoelectric inkjet printer, a desktop piezoelectric inkjet printer, or combinations thereof.

20. The method as defined in claim 18 wherein the pigment includes:
a cyan pigment present in an amount ranging from about 0.05 wt % to about 0.2 wt %;
a black pigment present in an amount ranging from about 0.1 wt % to about 0.6 wt %; and
a violet pigment present in an amount ranging from about 0.03 wt % to about 0.2 wt %.
